(19) United States
(12) Patent Application Publication
(10) Pub. No.: US 2025/0193810 A1
(43) Pub. Date: Jun. 12, 2025

(54) CONTROL APPARATUS, NON-TERRESTRIAL NETWORK APPARATUS, CONTROL METHOD, AND NON-TRANSITORY COMPUTER READABLE MEDIUM

(71) Applicant: NEC Corporation, Minato-ku, Tokyo (JP)

(72) Inventor: Kohei YOSHIDA, Tokyo (JP)

(73) Assignee: NEC Corporation, Minato-ku, Tokyo (JP)

(21) Appl. No.: 18/846,358

(22) PCT Filed: Mar. 22, 2022
(86) PCT No.: PCT/JP2022/013079

§ 371 Date: Sep. 12, 2024

(51) Int. Cl. H04W 52/42; H04B 7/185; H04W 24/04; H04W 84/06

(52) U.S. Cl. CPC H04W 52/42; H04B 7/185; H04W 24/04; H04W 84/06

(57) ABSTRACT

An acquisition unit in a control apparatus acquires the traffic volume and the remaining power amount of a non-terrestrial network apparatus. A control unit controls the non-terrestrial network apparatus based on the traffic volume and the remaining power amount acquired by the acquisition unit.

### TECHNICAL FIELD

The present disclosure relates to a control apparatus, a non-terrestrial network apparatus, a control method, and a non-transitory computer readable medium.

### BACKGROUND ART

Various techniques related to a non-terrestrial network (NTN) have been proposed (for example, Patent Literature 1). Patent Literature 1 proposes a technique for controlling an artificial satellite included in the NTN.

### CITATION LIST

### Patent Literature

Patent Literature 1: Published Japanese Translation of PCT International Publication for Patent Application, No. 2018-530957

Patent Literature 2: International Patent Publication No. WO2020/250709

### SUMMARY OF INVENTION

### Technical Problem

The inventors have found that the operation of a non-terrestrial network apparatus can become unstable because the time during which the non-terrestrial network apparatus can charge its battery using solar power generation is limited. Then, the present inventors have found that the non-terrestrial network apparatus can be operated more stably by controlling the non-terrestrial network apparatus based on the traffic volume and the remaining power amount of the non-terrestrial network apparatus.

It is an object of the present disclosure to provide a control apparatus, a non-terrestrial network apparatus, a control method, and a non-transitory computer readable medium that can stably operate a non-terrestrial network apparatus.

### Solution to Problem

A control apparatus according to a first aspect includes:
an acquisition means for acquiring a traffic volume and a remaining power amount of a non-terrestrial network apparatus moving on a predetermined orbit; and
a control means for controlling the non-terrestrial network apparatus based on the acquired traffic volume and remaining power amount.

A control method according to a second aspect includes:
acquiring a traffic volume and a remaining power amount of a non-terrestrial network apparatus moving on a predetermined orbit; and
controlling the non-terrestrial network apparatus based on the acquired traffic volume and remaining power amount.

A non-transitory computer readable medium according to a third aspect stores a program causing a control apparatus to execute processing including:
acquiring a traffic volume and a remaining power amount of a non-terrestrial network apparatus moving on a predetermined orbit; and
controlling the non-terrestrial network apparatus based on the acquired traffic volume and remaining power amount.

### ADVANTAGEOUS EFFECTS OF INVENTION

According to the present disclosure, it is possible to provide a control apparatus, a non-terrestrial network apparatus, a control method, and a non-transitory computer readable medium that can stably operate a non-terrestrial network apparatus.

### BRIEF DESCRIPTION OF DRAWINGS

FIG. 1 is a block diagram illustrating an example of a control apparatus according to a first example embodiment.

FIG. 2 is a block diagram illustrating an example of a control apparatus according to a second example embodiment.

FIG. 3 is a diagram for explaining the acquisition of an expected traffic volume.

FIG. 4 is a block diagram illustrating an example of a control apparatus according to a third example embodiment.

FIG. 5 is a block diagram illustrating an example of a control apparatus according to a fifth example embodiment.

FIG. 6 is a flowchart illustrating an example of a processing operation of the control apparatus according to the fifth example embodiment.

FIG. 7 is a diagram for explaining a processing operation of the control apparatus according to the fifth example embodiment.

FIG. 8 is a diagram illustrating a hardware configuration example of a control apparatus.

### EXAMPLE EMBODIMENT

Hereinafter, example embodiments of the present disclosure will be described with reference to the diagrams. In addition, in the following description and diagrams, omission and simplification are made as appropriate for clarity of description. In addition, in each of the following diagrams, the same elements are denoted by the same reference numerals, and repeated descriptions thereof will be omitted as necessary. In the present disclosure, unless otherwise specified, “at least one of A or B (A/B)” may mean any one of A and B or may mean both A and B. Similarly, when “at least one of” is used for three or more elements, this may mean any one of these elements or may mean any plurality of elements (including all elements).

### First Example Embodiment

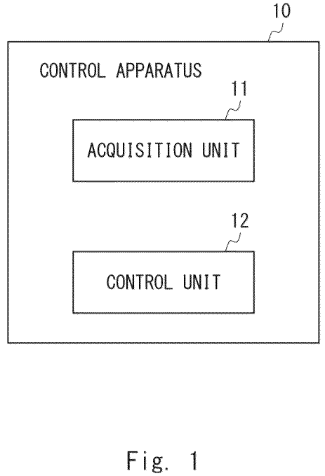

FIG. 1 is a block diagram illustrating an example of a control apparatus according to a first example embodiment. The control apparatus 10 illustrated in FIG. 1 controls a non-terrestrial network apparatus (not illustrated). The control apparatus 10 may be included in a non-terrestrial network apparatus (not illustrated). Alternatively, the control apparatus 10 may be an apparatus separate from a non-terrestrial network apparatus (not illustrated). In this case, the control apparatus 10 may be connected to a non-terrestrial network apparatus (not illustrated) by wire, or may be provided on the ground or in another non-terrestrial network apparatus (not illustrated) and wirelessly connected to the non-terrestrial network apparatus (not illustrated).

The non-terrestrial network apparatus (not illustrated) is an apparatus included in a non-terrestrial network (NTN), and is a flight vehicle that moves on a “predetermined orbit”. The non-terrestrial network apparatus (not illustrated) may be, for example, a geostationary orbit satellite (GEO), a low earth orbit satellite (LEO), or a high altitude platform station (HAPS).

The non-terrestrial network apparatus (not illustrated) includes a battery and a solar power generation system, and charges (hereinafter, this charging may be referred to as “solar charging”) the battery with electric power generated by the solar power generation system. Here, the orbit of the non-terrestrial network apparatus (not illustrated) includes, for example, a position that corresponds to daytime and is suitable for solar charging the battery or capable of solar charging the battery (hereinafter, may be referred to as an “appropriate position for solar charging” or a “possible position for solar charging”). In addition, the orbit of the non-terrestrial network apparatus (not illustrated) includes, for example, a position that corresponds to night and is not suitable for solar charging the battery or not capable of solar charging the battery (hereinafter, may be referred to as an “inappropriate position for solar charging” or an “impossible position for solar charging”). Therefore, in order to stably control the non-terrestrial network apparatus (not illustrated), the remaining power amount of the battery of the non-terrestrial network apparatus (not illustrated) is an important parameter.

In FIG. 1, the control apparatus 10 includes an acquisition unit 11 and a control unit 12.

The acquisition unit 11 acquires a traffic volume and a remaining power amount of the non-terrestrial network apparatus (not illustrated). The “traffic volume” is a communication traffic volume of the non-terrestrial network apparatus (not illustrated). In addition, for example, when the current position of the non-terrestrial network apparatus (not illustrated) is an “inappropriate position for solar charging” (or an “impossible position for solar charging”), the “traffic volume” is a traffic volume predicted while the non-terrestrial network apparatus moves from the current position to the next “appropriate position for solar charging” (or the “possible position for solar charging”). The “remaining power amount” is the amount of power remaining in the battery of the non-terrestrial network apparatus (not illustrated).

The control unit 12 controls the non-terrestrial network apparatus (not illustrated) based on the traffic volume and the remaining power amount acquired by the acquisition unit 11. For example, the control unit 12 may control the power of the beam of the non-terrestrial network apparatus (not illustrated) formed by beamforming, or may control the power and diameter of the beam. These will be described in detail in a fourth example embodiment. Alternatively, for example, the control unit 12 may set the non-terrestrial network apparatus (not illustrated) as either a preferentially used apparatus or a non-preferentially used apparatus. These will be described in detail in a fifth example embodiment.

As described above, according to the first example embodiment, the acquisition unit 11 in the control apparatus 10 acquires the traffic volume and the remaining power amount of the non-terrestrial network apparatus (not illustrated). The control unit 12 controls the non-terrestrial network apparatus (not illustrated) based on the traffic volume and the remaining power amount acquired by the acquisition unit 11.

With the configuration of the control apparatus 10, the non-terrestrial network apparatus (not illustrated) can be controlled based on the remaining power amount of the battery of the non-terrestrial network apparatus (not illustrated), which is an important parameter for stably controlling the non-terrestrial network apparatus (not illustrated). As a result, the non-terrestrial network apparatus (not illustrated) can be operated stably.

### Second Example Embodiment

A second example embodiment relates to a variation in calculation of a traffic volume.

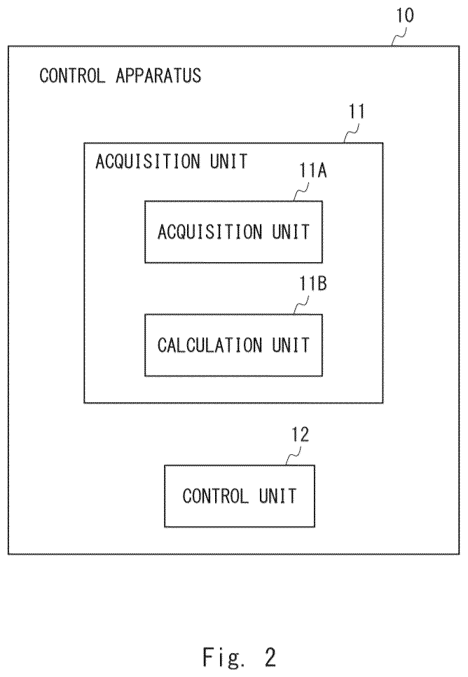

FIG. 2 is a block diagram illustrating an example of a control apparatus according to a second example embodiment. In FIG. 2, the control apparatus 10 includes an acquisition unit 11 and a control unit 12. The acquisition unit 11 includes an acquisition unit 11A and a calculation unit 11B.

The acquisition unit 11A acquires the traffic volume of another non-terrestrial network apparatus (control target of interest; not illustrated) located between the current position of the non-terrestrial network apparatus (not illustrated) and the possible position for solar charging on the “predetermined orbit”, as a “expected traffic volume”, from another non-terrestrial network apparatus (not illustrated).

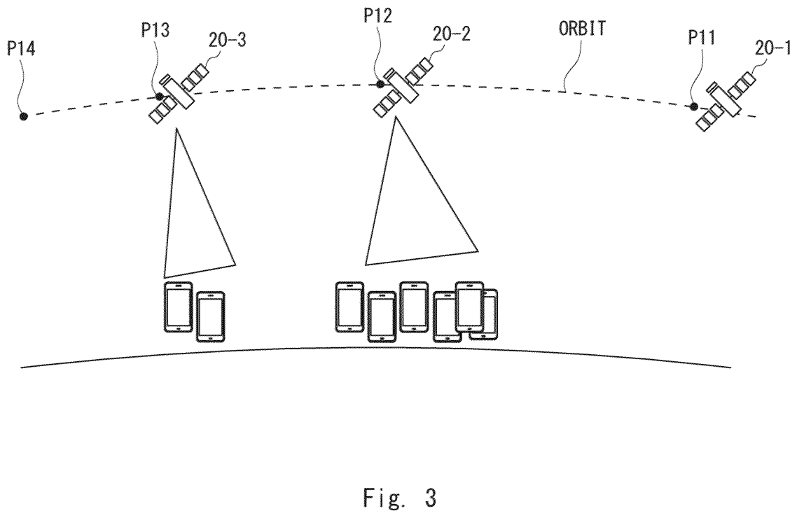

FIG. 3 is a diagram for explaining the acquisition of the expected traffic volume. In FIG. 3, a non-terrestrial network apparatus 20-1 is a control target non-terrestrial network apparatus of interest. The non-terrestrial network apparatus 20-1 is located at a position P11 which is a current position on the orbit. In addition, non-terrestrial network apparatuses 20-2 and 20-3 are located at positions P12 and P13 on the orbit, respectively. It is assumed that the positions P11, P12, and P13 are “inappropriate positions for solar charging” (or “impossible positions for solar charging”). A position P14 illustrated in FIG. 3 is a position at which the “inappropriate position for solar charging” (or the “impossible position for solar charging”) is switched to the “appropriate position for solar charging” (or the “possible position for solar charging”). That is, the position P14 illustrated in FIG. 3 is the next “appropriate position for solar charging” (or “possible position for solar charging”).

In this situation, the acquisition unit 11A acquires the current traffic volumes of the non-terrestrial network apparatuses 20-2 and 20-3 as the “expected traffic volume”. That is, the non-terrestrial network apparatus 20-1 moves on the orbit so as to follow the non-terrestrial network apparatuses 20-2 and 20-3. Therefore, the traffic volumes of the non-terrestrial network apparatuses 20-2 and 20-3 moving ahead can be regarded as the future traffic volume of the non-terrestrial network apparatus 20-1.

The calculation unit 11B calculates the traffic volume up to the “appropriate position for solar charging” (or the “possible position for solar charging”) of the non-terrestrial network apparatus 20-1 (control target of interest) based on the traffic volumes of the non-terrestrial network apparatuses 20-2 and 20-3 acquired by the acquisition unit 11A. For example, the calculation unit 11B calculates the traffic volume up to the “appropriate position for solar charging” (or the “possible position for solar charging”) of the non-terrestrial network apparatus 20-1 by adding the current traffic volumes (that is, the expected traffic volume of the non-terrestrial network apparatus 20-1) of the non-terrestrial network apparatuses 20-2 and 20-3 acquired by the acquisition unit 11A.

As described above, according to the second example embodiment, the acquisition unit 11A in the control apparatus 10 acquires the current traffic volumes of the non-terrestrial network apparatuses 20-2 and 20-3. The calculation unit 11B calculates the traffic volume up to the “appropriate position for solar charging” (or the “possible position for solar charging”) of the non-terrestrial network apparatus 20-1 based on the traffic volumes of the non-terrestrial network apparatuses 20-2 and 20-3 acquired by the acquisition unit 11A.

With the configuration of the control apparatus 10, it is possible to accurately calculate the traffic volume up to the “appropriate position for solar charging” (or the “possible position for solar charging”) of the non-terrestrial network apparatus 20-1 (control target of interest).

### Third Example Embodiment

A third example embodiment relates to another variation in the calculation of a traffic volume.

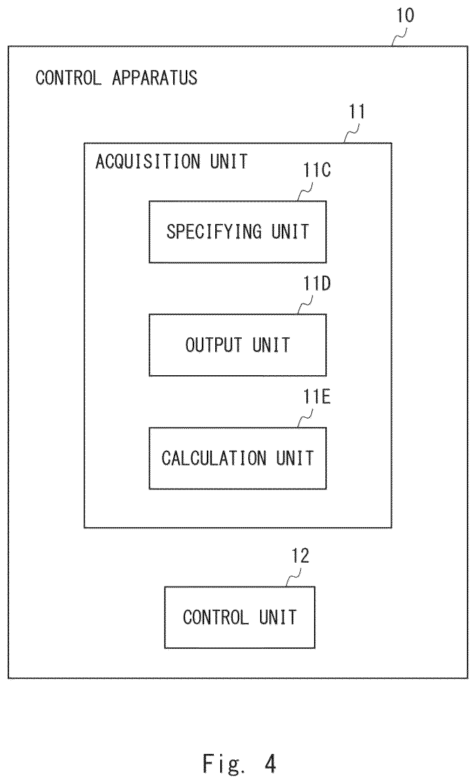

FIG. 4 is a block diagram illustrating an example of a control apparatus according to a third example embodiment. In FIG. 4, the control apparatus 10 includes an acquisition unit 11 and a control unit 12. The acquisition unit 11 includes a specifying unit 11C, an output unit 11D, and a calculation unit 11E.

The specifying unit 11C specifies a plurality of areas located under the orbit between the current position P11 of the non-terrestrial network apparatus 20-1 and the position P14 (hereinafter, may be referred to as “passing areas”) and a scheduled time at which the non-terrestrial network apparatus 20-1 passes through each area (hereinafter, may be referred to as a “scheduled passing time”).

The output unit 11D outputs “information regarding the expected traffic volume” corresponding to each combination of the passing area and the scheduled passing time specified by the specifying unit 11C. For example, the output unit 11D has a “trained model”. When a combination of the passing area and the scheduled passing time is received, the model outputs the “expected traffic volume” corresponding to the combination. In addition, for the learning of this model, for example, a combination of the area acquired by the acquisition unit 11A of the second example embodiment and the expected traffic volume may be used.

The calculation unit 11E calculates the traffic volume up to the “appropriate position for solar charging” (or the “possible position for solar charging”) of the non-terrestrial network apparatus 20-1 (control target of interest) based on a plurality of expected traffic volumes output from the output unit 11D for a plurality of combinations of the passing area and the scheduled passing time. For example, the calculation unit 11E calculates the traffic volume up to the “appropriate position for solar charging” (or the “possible position for solar charging”) of the non-terrestrial network apparatus 20-1 by adding a plurality of expected traffic volumes output from the output unit 11D for a plurality of combinations of the passing area and the scheduled passing time.

As described above, according to the third example embodiment, the output unit 11D in the control apparatus 10 outputs a traffic volume corresponding to each combination of the passing area and the scheduled passing time specified by the specifying unit 11C. The calculation unit 11E calculates the traffic volume of the non-terrestrial network apparatus 20-1 based on a plurality of expected traffic volumes output from the output unit 11D for a plurality of combinations of the passing area and the scheduled passing time.

With the configuration of the control apparatus 10, it is possible to accurately calculate the traffic volume up to the “appropriate position for solar charging” (or the “possible position for solar charging”) of the non-terrestrial network apparatus 20-1 (control target of interest).

### Fourth Example Embodiment

A fourth example embodiment relates to a variation in control for a non-terrestrial network apparatus. Since the basic configuration of a control apparatus according to the fourth example embodiment is the same as that of the control apparatus 10 according to the first example embodiment, this will be described with reference to FIG. 1.

In the control apparatus 10 according to the fourth example embodiment, an acquisition unit 11 acquires the traffic volume and the remaining power amount of the non-terrestrial network apparatus 20-1. The method for acquiring the traffic volume of the non-terrestrial network apparatus 20-1 may be the method described in the second example embodiment or the method described in the third example embodiment. In addition, the method for acquiring information on the remaining power amount of the battery of the non-terrestrial network apparatus 20-1 is not particularly limited. For example, the acquisition unit 11 may receive the report of the remaining power amount from the non-terrestrial network apparatus 20-1 at a predetermined cycle.

In the control apparatus 10 according to the fourth example embodiment, the control unit 12 controls the power of the beam of the non-terrestrial network apparatus 20-1 based on the traffic volume and the remaining power amount acquired by the acquisition unit 11. The non-terrestrial network apparatus 20-1 includes an array antenna including a plurality of antenna elements. By controlling the phases of a plurality of signals radiated from a plurality of used antenna elements, the radiation direction of the transmission beam radiated from the non-terrestrial network apparatus 20-1 can be controlled. In addition, by controlling the power of the plurality of signals radiated from the plurality of antenna elements, the power of the transmission beam radiated from the non-terrestrial network apparatus 20-1 can be controlled. That is, the control unit 12 forms a “power control signal” for controlling the transmission power of each used antenna element based on the traffic volume and the remaining power amount acquired by the acquisition unit 11. This power control signal is transmitted to the non-terrestrial network apparatus 20-1. Then, the control unit of the non-terrestrial network apparatus 20-1 receives the power control signal, and controls the transmission power of each used antenna element based on the power control signal.

For example, the control unit 12 determines the amount of power allowed to be used (hereinafter, may be referred to as “allowed power use amount”) until the non-terrestrial network apparatus 20-1 moves from the current position P11 of the non-terrestrial network apparatus 20-1 to the position P14, which is the next appropriate position for solar charging (or “possible position for solar charging”), of the remaining power amount of the non-terrestrial network apparatus 20-1. The “allowed power use amount” is equal to or less than the remaining power amount. Then, the control unit 12 determines the transmission power of each used antenna element of the non-terrestrial network apparatus 20-1 such that the power consumed by the traffic volume acquired by the acquisition unit 11 is equal to or less than the “allowed power use amount”. Here, the unit of the traffic volume may be, for example, a bit (that is, a unit representing the amount of information). The unit of the amount of power may be watt-hour. For example, the control unit 12 calculates the amount of power allowed for the unit traffic by dividing the “allowed power use amount” by the traffic volume. Then, the control unit 12 may specify the power of the array antenna corresponding to the amount of power allowed for the unit traffic by using the correspondence relationship between the power of the array antenna and the amount of power allowed for the unit traffic. Then, the control unit 12 forms a “power control signal” including information indicating the transmission power of each used antenna element.

As described above, according to the fourth example embodiment, the control unit 12 in the control apparatus 10 controls the power of the beam of the non-terrestrial network apparatus 20-1 based on the traffic volume and the remaining power amount acquired by the acquisition unit 11.

With the configuration of the control apparatus 10, it is possible to control the power of the beam of the non-terrestrial network apparatus 20-1 based on the traffic volume and the remaining power amount before the next chargeable state. As a result, it is possible to avoid a state in which the remaining power of the non-terrestrial network apparatus 20-1 is exhausted and communication cannot be performed, and thus, it is possible to stably operate the non-terrestrial network apparatus.

### Modified Examples

The control unit 12 may control the power and the diameter of the beam of the non-terrestrial network apparatus 20-1 based on the traffic volume and the remaining power amount acquired by the acquisition unit 11. For example, as described above, the control unit 12 calculates the amount of power allowed for the unit traffic by dividing the “allowed power use amount” by the traffic volume. Then, the control unit 12 specifies the power of the array antenna corresponding to the amount of power allowed for the unit traffic by using the correspondence relationship between the power of the array antenna and the amount of power allowed for the unit traffic. Then, the control unit 12 specifies the number of used antenna elements allowed to be used for communication and the transmission power allowed for each used antenna element based on the specified power of the array antenna. By changing the number of used antenna elements, the diameter of the beam can be changed. Here, as the specified power of the array antenna decreases, the control unit 12 increases the number of used antenna elements and decreases the transmission power allowed for each used antenna element. As a result, the antenna area of the non-terrestrial network apparatus 20-1 increases to enhance the directivity of the beam, while the power consumption of the array antenna falls within the amount of power allowed for the unit traffic.

### Fifth Example Embodiment

A fifth example embodiment relates to an example embodiment in which a non-terrestrial network apparatus is set as a preferentially used apparatus or a non-preferentially used apparatus.

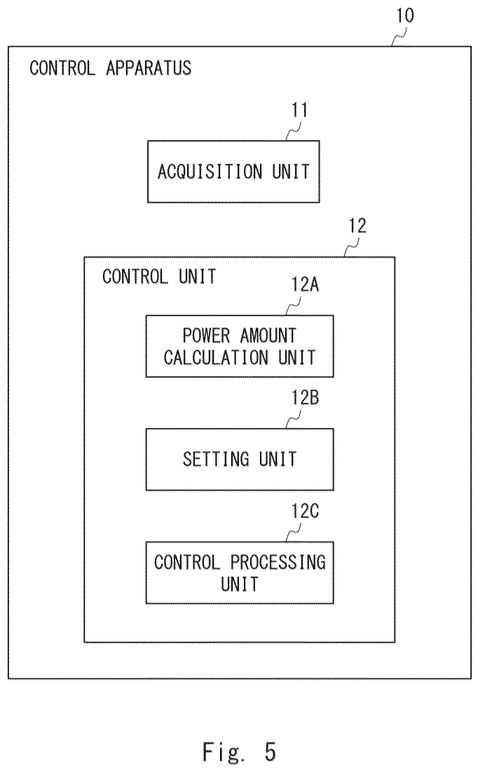

FIG. 5 is a block diagram illustrating an example of a control apparatus according to a fifth example embodiment. In FIG. 5, the control apparatus 10 includes an acquisition unit 11 and a control unit 12.

In the control apparatus 10 according to the fifth example embodiment, an acquisition unit 11 acquires the traffic volume and the remaining power amount of the non-terrestrial network apparatus 20-1. The method for acquiring the traffic volume of the non-terrestrial network apparatus 20-1 may be the method described in the second example embodiment or the method described in the third example embodiment. In addition, the method for acquiring information on the remaining power amount of the battery of the non-terrestrial network apparatus 20-1 is not particularly limited. For example, the acquisition unit 11 may receive the report of the remaining power amount from the non-terrestrial network apparatus 20-1 at a predetermined cycle.

In the control apparatus 10 according to the fifth example embodiment, the control unit 12 sets the non-terrestrial network apparatus 20-1 as either a “preferentially used apparatus” or a “non-preferentially used apparatus” based on the traffic volume and the remaining power amount acquired by the acquisition unit 11. The “preferentially used apparatus” is an apparatus that is given priority in communicating with a terminal on the ground. In addition, the “non-preferentially used apparatus” is an apparatus that communicates with a terminal on the ground as a supplement to the “preferentially used apparatus”. For example, the control unit 12 may perform control to reduce the beam power described in the fourth example embodiment or to enhance the directivity of the beam and reduce the beam power for the “non-preferentially used apparatus”.

For example, as illustrated in FIG. 5, the control unit 12 includes a power amount calculation unit 12A, a setting unit 12B, and a control processing unit 12C.

For example, the power amount calculation unit 12A calculates a “expected power consumption” used between the current position P11 and the possible position for solar charging P14 by multiplying the traffic volume acquired by the acquisition unit 11 by the “unit power amount”. The “unit power amount” is the amount of power consumed by unit traffic in the non-terrestrial network apparatus.

The setting unit 12B sets the non-terrestrial network apparatus 20-1 as either a preferentially used apparatus or a non-preferentially used apparatus based on the expected power consumption calculated by the power amount calculation unit 12A and the remaining power amount acquired by the acquisition unit 11. For example, the setting unit 12B determines the above-described “allowed power use amount”. The “allowed power use amount” may be, for example, 80% of the remaining power amount. Then, when the expected power consumption is equal to or less than the allowed power use amount, the setting unit 12B sets the non-terrestrial network apparatus 20-1 as a preferentially used apparatus. On the other hand, when the expected power consumption is larger than the allowed power use amount, the setting unit 12B sets the non-terrestrial network apparatus 20-1 as a non-preferentially used apparatus.

When the non-terrestrial network apparatus 20-1 is set as a non-preferentially used apparatus, the control processing unit 12C may perform control to reduce the beam power described in the fourth example embodiment or to enhance the directivity of the beam and reduce the beam power. In addition, when the non-terrestrial network apparatus 20-1 is set as a preferentially used apparatus, the control processing unit 12C may control the non-terrestrial network apparatus 20-1 to perform communication with a terminal that cannot communicate with another non-terrestrial network apparatus set as the non-preferentially used apparatus.

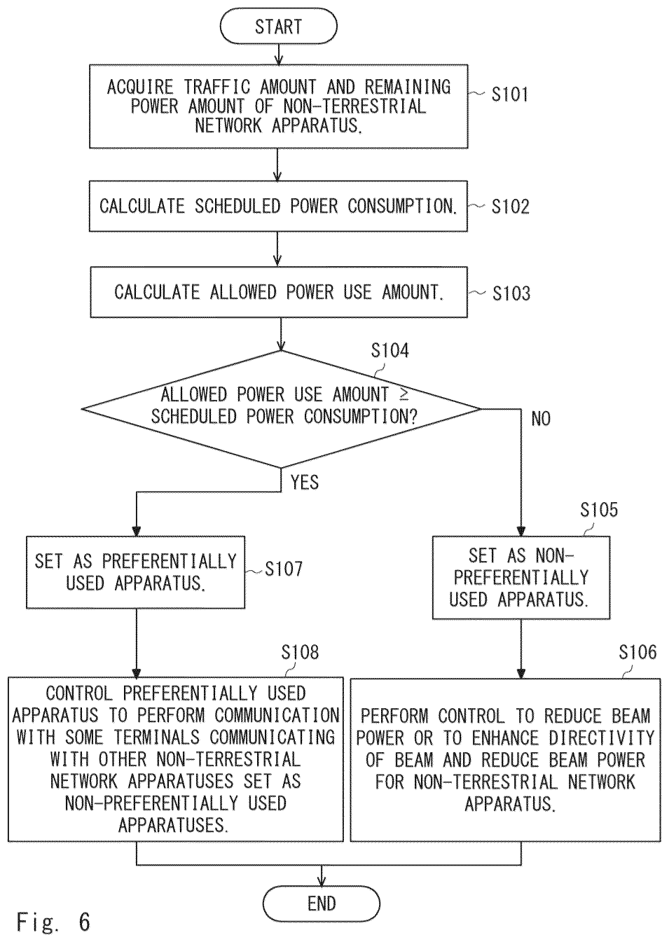

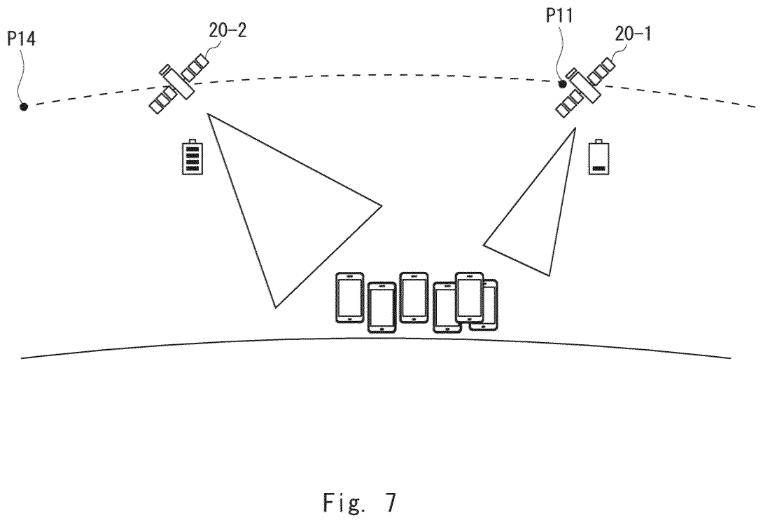

The operation of the control apparatus having the above configuration will be described. FIG. 6 is a flowchart illustrating an example of a processing operation of the control apparatus according to the fifth example embodiment. FIG. 7 is a diagram for explaining a processing operation of the control apparatus according to the fifth example embodiment.

The acquisition unit 11 in the control apparatus 10 acquires the traffic volume and the remaining power amount of the non-terrestrial network apparatus 20-1 (step S101). The method for acquiring the traffic volume of the non-terrestrial network apparatus 20-1 may be the method described in the second example embodiment or the method described in the third example embodiment. In addition, the method for acquiring information on the remaining power amount of the battery of the non-terrestrial network apparatus 20-1 is not particularly limited. For example, the acquisition unit 11 may receive the report of the remaining power amount from the non-terrestrial network apparatus 20-1 at a predetermined cycle.

For example, the power amount calculation unit 12A calculates a “expected power consumption” used between the current position P11 and the possible position for solar charging P14 by multiplying the traffic volume acquired by the acquisition unit 11 by the “unit power amount” (step S102).

The setting unit 12B calculates an “allowed power use amount” (step S103). The “allowed power use amount” may be, for example, 80% of the remaining power amount.

The setting unit 12B compares the “expected power consumption” with the “allowed power use amount” (step S104). If the “expected power consumption” is larger than the “allowed power use amount” (step S104: NO), the setting unit 12B sets the non-terrestrial network apparatus 20-1 as a non-preferentially used apparatus (step S105).

The control processing unit 12C performs control to reduce the beam power or to enhance the directivity of the beam and reduce the beam power for the non-terrestrial network apparatus 20-1 (step S106). FIG. 7 illustrates a state after control for enhancing the directivity of the beam and reducing the beam power is performed for the non-terrestrial network apparatus 20-1.

When the “expected power consumption” is equal to or less than the “allowed power use amount” (step S104: YES), the setting unit 12B sets the non-terrestrial network apparatus 20-1 as a preferentially used apparatus (step S107).

The control processing unit 12C controls the non-terrestrial network apparatus 20-1 to perform (start) communication with some terminals communicating with other non-terrestrial network apparatuses set as non-preferentially used apparatuses (step S108). As a result, since the preferentially used apparatus can assist the non-preferentially used apparatus that is short on power, communication in the non-terrestrial network can be stabilized. FIG. 7 illustrates a situation in which the non-terrestrial network apparatus 20-2 is set as a preferentially used apparatus.

As described above, according to the fifth example embodiment, the control unit 12 in the control apparatus 10 sets the non-terrestrial network apparatus as either a “preferentially used apparatus” or a “non-preferentially used apparatus” based on the traffic volume and the remaining power amount acquired by the acquisition unit 11.

With the configuration of the control apparatus 10, the power of the non-terrestrial network apparatus can be controlled in the entire non-terrestrial network. As a result, the non-terrestrial network apparatus can be operated stably.

### Other Example Embodiments

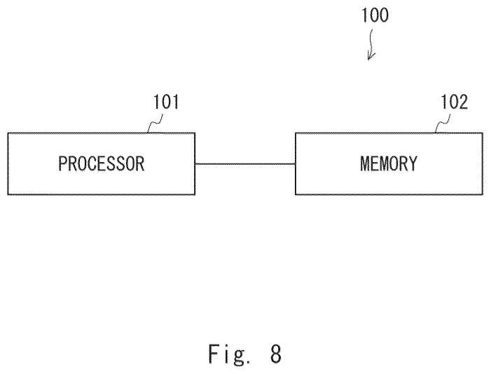

FIG. 8 is a diagram illustrating a hardware configuration example of a control apparatus. In FIG. 8, a control apparatus 100 includes a processor 101 and a memory 102. The processor 101 may be, for example, a microprocessor, a micro processing unit (MPU), or a central processing unit (CPU). The processor 101 may include a plurality of processors. The memory 102 is configured by a combination of a volatile memory and a nonvolatile memory. The memory 102 may include a storage located away from the processor 101. In this case, the processor 101 may access the memory 102 through an I/O interface (not illustrated).

Each control apparatus 10 according to the first to fifth example embodiments can have the hardware configuration illustrated in FIG. 8. The acquisition unit 11 and the control unit 12 of the control apparatus 10 according to the first to fifth example embodiments may be implemented by the processor 101 reading and executing a program stored in the memory 102. The program can be stored using various types of non-transitory computer readable media and supplied to the control apparatus 10. Examples of the non-transitory computer readable media include magnetic recording media (for example, flexible disks, magnetic tapes, or hard disk drives), magneto-optical recording media (for example, magneto-optical disks). Other examples of the non-transitory computer readable media include a read only memory (CD-ROM), a CD-R, and a CD-R/W. Other examples of the non-transitory computer readable media include a semiconductor memory. Examples of the semiconductor memory include a mask ROM, a programmable ROM (PROM), an erasable PROM (EPROM), a flash ROM, and a random access memory (RAM). In addition, the program may be supplied to the control apparatus 10 by various types of transitory computer readable media. Examples of the transitory computer readable media include electrical signals, optical signals, and electromagnetic waves. The transitory computer readable media can provide the program to the control apparatus 10 through a wired communication line such as an electric wire and optical fibers or a wireless communication line.

Although the invention of the present application has been described above with reference to the example embodiments, the invention of the present application is not limited to the above. Various modifications that can be understood by those skilled in the art can be made to the configuration and details of the invention of the present application within the scope of the invention.

Some or all of the above-described example embodiments may be described as in the following Supplementary Notes, but are not limited to the following Supplementary Notes.

### SUPPLEMENTARY NOTE 1

A control apparatus including:
an acquisition means for acquiring a traffic volume and a remaining power amount of a non-terrestrial network apparatus moving on a predetermined orbit; and
a control means for controlling the non-terrestrial network apparatus based on the acquired traffic volume and remaining power amount.

### SUPPLEMENTARY NOTE 2

The control apparatus according to Supplementary Note 1, wherein the acquisition means includes a calculation means for acquiring, from another non-terrestrial network apparatus located between a current position of the non-terrestrial network apparatus and a possible position for solar charging on the predetermined orbit, a traffic volume of the another non-terrestrial network apparatus as an expected traffic volume and calculating the traffic volume of the non-terrestrial network apparatus based on the expected traffic volume.

### SUPPLEMENTARY NOTE 3

The control apparatus according to Supplementary Note 1, wherein the acquisition means includes:
an output means for outputting an expected traffic volume corresponding to a combination of an area and a time; and
a calculation means for calculating the traffic volume of the non-terrestrial network apparatus based on an expected traffic volume output from the output means according to a combination of an area located under an orbit, through which the non-terrestrial network apparatus between a current position of the non-terrestrial network apparatus and a possible position for solar charging passes, and a scheduled time at which the non-terrestrial network apparatus passes through the area.

### SUPPLEMENTARY NOTE 4

The control apparatus according to any one of Supplementary Notes 1 to 3, wherein the control means controls power of a beam of the non-terrestrial network apparatus formed by beamforming based on the traffic volume and the remaining power amount of the non-terrestrial network apparatus.

### SUPPLEMENTARY NOTE 5

The control apparatus according to any one of Supplementary Notes 1 to 3, wherein the control means controls a diameter and power of a beam of the non-terrestrial network apparatus formed by beamforming based on the traffic volume and the remaining power amount of the non-terrestrial network apparatus.

### SUPPLEMENTARY NOTE 6

The control apparatus according to any one of Supplementary Notes 1 to 3, wherein the control means sets the non-terrestrial network apparatus as either a preferentially used apparatus or a non-preferentially used apparatus based on the traffic volume and the remaining power amount of the non-terrestrial network apparatus.

### SUPPLEMENTARY NOTE 7

The control apparatus according to Supplementary Note 2 or 3, wherein the control means includes:
a power amount calculation means for calculating an expected power consumption to be used between the current position and the possible position for solar charging by multiplying the traffic volume of the non-terrestrial network apparatus by a unit power amount that is an amount of power consumed by unit traffic; and
a setting means for setting the non-terrestrial network apparatus as either a preferentially used apparatus or a non-preferentially used apparatus based on the expected power consumption and the remaining power amount.

### SUPPLEMENTARY NOTE 8

A non-terrestrial network apparatus including: the control apparatus according to any one of Supplementary Notes 1 to 7.

### SUPPLEMENTARY NOTE 9

A control method including:
acquiring a traffic volume and a remaining power amount of a non-terrestrial network apparatus moving on a predetermined orbit; and controlling the non-terrestrial network apparatus based on the acquired traffic volume and remaining power amount.

### SUPPLEMENTARY NOTE 10

The control method according to Supplementary Note 9, wherein the acquiring the traffic volume and the remaining power amount of the non-terrestrial network apparatus includes acquiring, from another non-terrestrial network apparatus located between a current position of the non-terrestrial network apparatus and a possible position for solar charging on the predetermined orbit, a traffic volume of the another non-terrestrial network apparatus as an expected traffic volume and calculating the traffic volume of the non-terrestrial network apparatus based on the expected traffic volume.

### SUPPLEMENTARY NOTE 11

The control method according to Supplementary Note 9, wherein the acquiring the traffic volume and the remaining power amount of the non-terrestrial network apparatus includes:
outputting an expected traffic volume corresponding to a combination of an area and a time zone; and
calculating the traffic volume of the non-terrestrial network apparatus based on an expected traffic volume output according to a combination of an area located under an orbit, through which the non-terrestrial network apparatus between a current position of the non-terrestrial network apparatus and a possible position for solar charging passes, and a scheduled time at which the non-terrestrial network apparatus passes through the area.

### SUPPLEMENTARY NOTE 12

A non-transitory computer readable medium storing a program causing a control apparatus to execute processing including:
acquiring a traffic volume and a remaining power amount of a non-terrestrial network apparatus moving on a predetermined orbit; and
controlling the non-terrestrial network apparatus based on the acquired traffic volume and remaining power amount.

### REFERENCE SIGNS LIST

10 CONTROL APPARATUS
11 ACQUISITION UNIT
11A ACQUISITION UNIT
11B CALCULATION UNIT
11C SPECIFYING UNIT
11D OUTPUT UNIT
11E CALCULATION UNIT
12 CONTROL UNIT
12A POWER AMOUNT CALCULATION UNIT
12B SETTING UNIT
12C CONTROL PROCESSING UNIT
20 NON-TERRESTRIAL NETWORK APPARATUS

What is claimed is:

1. A control apparatus comprising:
at least one memory storing instructions, and
at least one processor configured to execute the instructions to:
acquire a traffic volume and a remaining power amount of a non-terrestrial network apparatus moving on a predetermined orbit; and
control the non-terrestrial network apparatus based on the acquired traffic volume and remaining power amount.

2. The control apparatus according to claim 1, wherein the at least one processor acquires, from another non-terrestrial network apparatus located between a current position of the non-terrestrial network apparatus and a possible position for solar charging on the predetermined orbit, a traffic volume of the another non-terrestrial network apparatus as an expected traffic volume and calculates the traffic volume of the non-terrestrial network apparatus based on the expected traffic volume.

3. The control apparatus according to claim 1, wherein the at least one processor
outputs an expected traffic volume corresponding to a combination of an area and a time; and
calculates the traffic volume of the non-terrestrial network apparatus based on an expected traffic volume output according to a combination of an area located under an orbit, through which the non-terrestrial network apparatus between a current position of the non-terrestrial network apparatus and a possible position for solar charging passes, and a scheduled time at which the non-terrestrial network apparatus passes through the area.

4. The control apparatus according to claim 1, wherein the at least one processor controls power of a beam of the non-terrestrial network apparatus formed by beamforming based on the traffic volume and the remaining power amount of the non-terrestrial network apparatus.

5. The control apparatus according to claim 1, wherein the at least one processor controls a diameter and power of a beam of the non-terrestrial network apparatus formed by beamforming based on the traffic volume and the remaining power amount of the non-terrestrial network apparatus.

6. The control apparatus according to claim 1, wherein the at least one processor sets the non-terrestrial network apparatus as either a preferentially used apparatus or a non-preferentially used apparatus based on the traffic volume and the remaining power amount of the non-terrestrial network apparatus.

7. The control apparatus according to claim 2, wherein the at least one processor includes:
calculates an expected power consumption to be used between the current position and the possible position for solar charging by multiplying the traffic volume of the non-terrestrial network apparatus by a unit power amount that is an amount of power consumed by unit traffic; and
sets the non-terrestrial network apparatus as either a preferentially used apparatus or a non-preferentially used apparatus based on the expected power consumption and the remaining power amount.

8. A non-terrestrial network apparatus comprising: the control apparatus according to claim 1.

9. A control method comprising:
acquiring a traffic volume and a remaining power amount of a non-terrestrial network apparatus moving on a predetermined orbit; and
controlling the non-terrestrial network apparatus based on the acquired traffic volume and remaining power amount.

10. The control method according to claim 9, wherein the acquiring the traffic volume and the remaining power amount of the non-terrestrial network apparatus includes acquiring, from another non-terrestrial network apparatus located between a current position of the non-terrestrial network apparatus and a possible position for solar charging on the predetermined orbit, a traffic volume of the another non-terrestrial network apparatus as an expected traffic volume and calculating the traffic volume of the non-terrestrial network apparatus based on the expected traffic volume.

11. The control method according to claim 9, wherein the acquiring the traffic volume and the remaining power amount of the non-terrestrial network apparatus includes:
outputting an expected traffic volume corresponding to a combination of an area and a time zone; and
calculating the traffic volume of the non-terrestrial network apparatus based on an expected traffic volume output according to a combination of an area located under an orbit, through which the non-terrestrial network apparatus between a current position of the non-terrestrial network apparatus and a possible position for solar charging passes, and a scheduled time at which the non-terrestrial network apparatus passes through the area.

12. A non-transitory computer readable medium storing a program causing a control apparatus to execute processing including:
acquiring a traffic volume and a remaining power amount of a non-terrestrial network apparatus moving on a predetermined orbit; and
controlling the non-terrestrial network apparatus based on the acquired traffic volume and remaining power amount.

13. The control method according to claim 9, wherein the controlling of the non-terrestrial network apparatus includes controlling power of a beam of the non-terrestrial network apparatus formed by beamforming based on the traffic volume and the remaining power amount of the non-terrestrial network apparatus.

14. The control method according to claim 9, wherein the controlling of the non-terrestrial network apparatus includes controlling a diameter and power of a beam of the non-terrestrial network apparatus formed by beamforming based on the traffic volume and the remaining power amount of the non-terrestrial network apparatus.

15. The control method according to claim 9, wherein the controlling of the non-terrestrial network apparatus includes setting the non-terrestrial network apparatus as either a preferentially used apparatus or a non-preferentially used apparatus based on the traffic volume and the remaining power amount of the non-terrestrial network apparatus.

16. The control method according to claim 10, wherein the controlling of the non-terrestrial network apparatus includes:
calculating an expected power consumption to be used between the current position and the possible position for solar charging by multiplying the traffic volume of the non-terrestrial network apparatus by a unit power amount that is an amount of power consumed by unit traffic; and
setting the non-terrestrial network apparatus as either a preferentially used apparatus or a non-preferentially used apparatus based on the expected power consumption and the remaining power amount.
